(19) United States
(12) Patent Application Publication
(10) Pub. No.: US 2007/0190972 A1
(43) Pub. Date: Aug. 16, 2007

(54) METHOD AND SYSTEM FOR IMPLEMENTING WIRELESS INTELLIGENT SERVICES

(76) Inventor: Yongfeng CAI, Shenzhen, Guangdong, (CN)

Correspondence Address: LADAS & PARRY LLP, 224 SOUTH MICHIGAN AVENUE, SUITE 1600, CHICAGO, IL, 60604, US

(21) Appl. No.: 11/669,248

(22) Filed: Jan. 31, 2007

Related U.S. Application Data
(63) Continuation of application No. PCT/CN05/02278, filed on Dec. 22, 2005.

(30) Foreign Application Priority Data
Dec. 29, 2004 (CN) 200410102676.8

(51) Int. Cl. H04M 11/00

(52) U.S. Cl. 455/406; 455/461

(57) ABSTRACT

A method for implementing wireless intelligent services includes: receiving a call and triggering an intelligent service corresponding to the call at a Service Control Point (SCP); receiving a processing result of the intelligent service from the SCP; routing the call to a called party according to the processing result; receiving a call control directive message carrying charging information sent from the SCP; and sending the charging information in the call control directive message to a wireless communication terminal. The present invention makes it possible to implement a centralized management of wireless intelligent services and a centralized charging control by using the intelligent network.

### FIELD OF THE TECHNOLOGY

The present invention relates to a wireless public telephone technology, and more specifically, to a method, a system, a Mobile Switching Center (MSC), a Service Control Point (SCP) and a wireless communication terminal for implementing wireless intelligent services.

### BACKGROUND OF THE INVENTION

Conventional intelligent public telephones are implemented in a wire manner. Information is transmitted between a switching network and terminals through telephone lines, and the switching network sends charging information to terminals in a Dual Tone Multi Frequency (DTMF) manner. A telecommunication company needs to lay telephone lines on locations where public telephone services are applied for. One public telephone needs one telephone line, and therefore, both workload and cost of laying lines are rather high.

A wireless intelligent service, such as a Wireless Intelligent Public Telephone (WIPT) service may implement a conventional intelligent telephone service in a wireless manner. And the present invention provides a method, a system, an MSC, an SCP and a wireless communication terminal for implementing wireless intelligent services.

### SUMMARY OF THE INVENTION

In view of the above, some embodiments of the present invention provide a method, a system, an MSC, an SCP and a wireless communication terminal for implementing wireless intelligent services.

In an embodiment of the present invention, a method for implementing wireless intelligent services may include:

receiving a call and triggering an intelligent service corresponding to the call at an SCP;

receiving a processing result of the intelligent service sent from the SCP;

routing the call to a called party according to the processing result;

receiving a call control directive message carrying charging information sent from the SCP; and

sending the charging information in the call control directive message to a wireless communication terminal.

In another embodiment of the present invention, a system for implementing wireless intelligent services may include an MSC, an SCP and a wireless communication terminal, wherein

the MSC is configured to receive a call and trigger an intelligent service corresponding to the call at the SCP; receive a processing result of the intelligent service from the SCP; route the call to a called party according to the processing result; receive a call control directive message carrying charging information sent from the SCP; and send the charging information in the call control directive message to the wireless communication terminal;

the SCP is configured to process the intelligent service and send the call control directive message carrying charging information; and

the wireless communication terminal is configured to display the charging information.

Also in another embodiment of the present invention, an MSC may include a component configured to:

receive a call and triggering an intelligent service corresponding to the call at the SCP;

receive a processing result of the intelligent service from the SCP; routing the call to a called party according to the processing result;

receive a call control directive message carrying charging information sent from the SCP; and

send the charging information in the call control directive message to the wireless communication terminal.

Also in another embodiment of the present invention, an SCP may include a unit for processing an intelligent service and a unit for sending a call control directive message carrying charging information to an MSC.

Also in another embodiment of the present invention, a wireless communication terminal may include a component configured to receive charging information from an MSC, and display the charging information.

The implementation of the wireless intelligent services, such as the WIPT services in accordance with the embodiments of the present invention has features such as wide coverage, high mobility, convenient management and maintenance, and low cost. Such an implementation using an intelligent network technology makes centralized management of wireless intelligent services and centralized control of charging possible. In addition, for the WIPT services, the present invention is applicable to the attended mode intelligent public telephone as well as the unattended mode intelligent public telephone. Furthermore, embodiments of the present invention, by means of carrying the metering duration and metering cost in the charging information sent from the SCP to the WIPT terminal, enables the wireless communication terminal such as the WIPT terminal to automatically implement charging function in a certain extent.

### BRIEF DESCRIPTION OF THE DRAWINGS

FIG. 1 is a simplified diagram illustrating the networking of the wireless intelligent services according to an embodiment of the present invention.

FIG. 2 is a simplified flowchart of implementing the wireless intelligent service according to another embodiment of the present invention.

FIG. 3 is a schematic diagram of automatically updating the display of cost on a wireless communication terminal according to an embodiment of the present invention.

### DETAILED DESCRIPTION OF THE INVENTION

In embodiments of the present invention, the WIPT service is taken as an example of a wireless intelligent service, and is implemented via a Code Division Multiple Access (CDMA) network. Those skilled in the art should understand that the wireless intelligent services may also be other services. When a wireless communication terminal is registered as a WIPT and a subscriber initiates a call using the communication terminal, a call cost may be displayed timely, and the call cost of a public telephone may be balanced. The call cost information may be the call cost, or a combination of the call cost with an account balance, or a combination of the call cost with call duration.

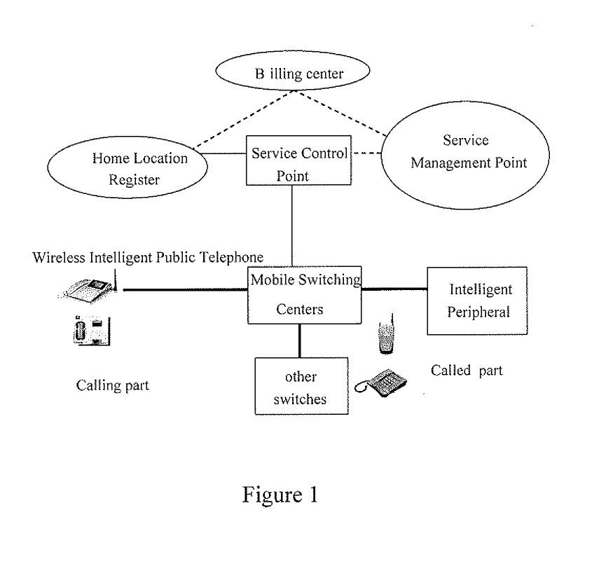

As shown in FIG. 1, the network for a wireless intelligent service may include a terminal telephone, an MSC of the CDMA network, a Home Location Register (HLR), an Intelligent Peripheral (IP), an SCP, a Service Management Point (SMP), etc., where the SCP is a core device, and is in charge of the charging and call control of the WIPT service. In accordance with the present invention embodiment, the calling party may be a CDMA subscriber, and the called party may be a PSTN subscriber or a subscriber of a wireless mobile communication network, such as a GSM network or a CDMA network, or any other network.

The terminal phone is a WIPT terminal which accesses the network in a wireless manner. Those skilled in the art should understand that the terminal phone may be any kind of wireless communication terminals. The shape of the terminal phone may be similar to that of an ordinary fixed-line telephone except that the telephone line of the ordinary fixed-line telephone is replaced by an antenna. The apparent difference between the WIPT terminal and the ordinary terminal is that the WIPT terminal may display such information as call duration and/or advice of Charge at the End of Conversation.

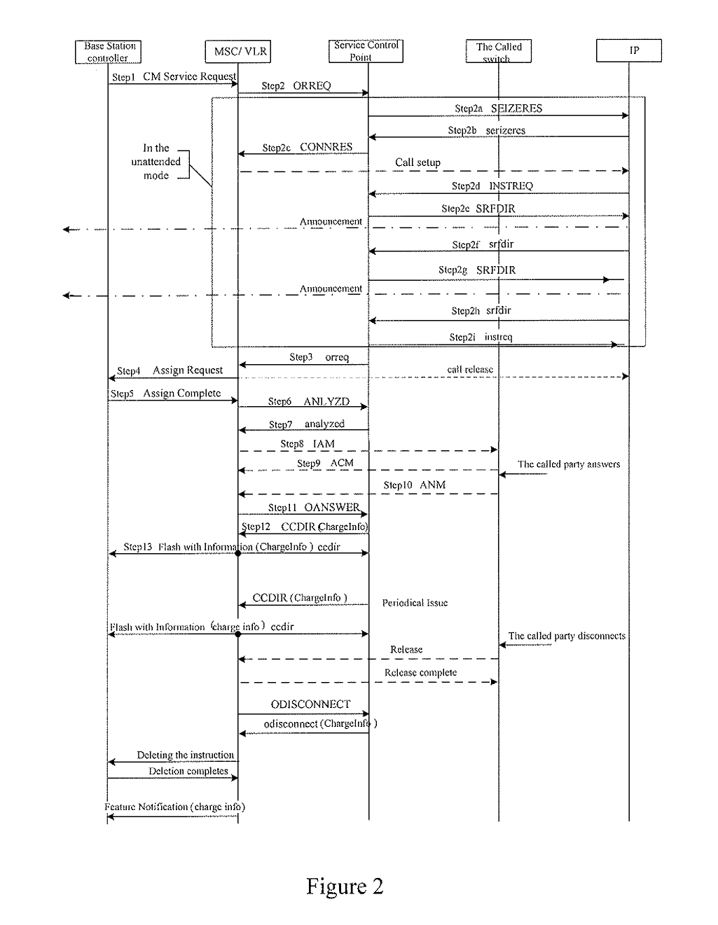

As shown in FIG. 2, the flow for implementing wireless intelligent services in accordance with an embodiment of the present invention is described as follows:

Step 1: When a subscriber dials to initiate a call by a wireless communication terminal, a Base Station Controller (BSC) sends a service request message CM Service Request to a MSC. In this embodiment, the wireless communication terminal is a WIPT terminal.

Steps 2˜3: Upon receiving the service request message, the MSC analysis that the calling subscriber is an intelligent subscriber, triggers an Origination_Attempt_Authorized trigger, and sends an request message ORREQ to a SCP. The SCP performs an authentication based on the calling number, and upon determining that the state of the subscriber is normal, performs the process as follows based on whether the telephone is an attended mode or an unattended mode:

If the telephone is an attended mode public telephone, the call cost of the subscriber may be recorded in the subscriber account which corresponds to the calling number. Therefore, the SCP only needs obtaining the subscriber account corresponding to the calling number so that the subsequent call cost may be recorded in the account. Subsequently, the SCP sends an original request response message orreq to the MSC to indicate that the subsequent call processing should continue. Then the process continues with Steps 4˜5.

If the telephone is an unattended mode public telephone, the subscriber pays the call cost by a telephone card, and in such a case, relevant information such as a card number, a password and a called number may be obtained in a collect digits upon announcement manner. Therefore, the SCP needs obtaining the subscriber account corresponding to the telephone card such that the subsequent call cost may be recorded in the account. The rough flow is described in Steps 2a˜2i shown in FIG. 2. As shown in FIG. 2, the SCP sends a seizing resource message SEIZERES to the IP first and the IP may return a seizing resource response message seizeres to indicate that the resource is allocated successfully. The SCP sends a message to instruct the MSC to set up a call leg to the IP, and the message sent by the SCP is a connect resource message CONNRES. The MSC sets up a call leg to the IP. The IP returns an instruction request message INSTREQ to instruct the SCP to continue the subsequent service flow. The SCP sends to the IP a special resource function directive message SRFDIR to direct the IP to play an announcement, such as “please input a card number and the password”. The subscriber inputs the card number and the password according to the prompt, and the IP sends to the SCP a special resource function directive response message srfdir which carries the card number and the password inputted by the subscriber. Upon determining by analyzing the card number and the password that the card is available and has an account balance, the SCP sends to the IP the SRFDIR to direct the IP to play an announcement such as “please input the called number that you want to connect to”. The subscriber inputs the number according to the prompt, and the IP sends to the SCP a srfdir message which carries the number inputted by the subscriber. The SCP sends an instruction request response message instreq to the IP, and sends to the MSC the orreq which includes the number inputted by the subscriber and the instruction instructing the MSC to continue the call processing. The MSC releases the call leg to the IP. Then the process continues with Steps 4˜5. Those skilled in the art should understand that, the actual flows may be different with respect to difference performances of the terminals. For some terminals, for example, the terminals may directly read information of the card and report the card information, and it is not necessary to manually input the card information by the subscriber.

Steps 4˜5: The MSC analyzes the called number and prepares to route the call according to the called number. At the same time, The MSC sends an assign request message Assign Request to the BSC to instruct the BSC to assign call paths and corresponding wireless resources. Then the BSC may return an Assign Complete message to indicate that resources are assigned successfully.

Step 6: The MSC triggers a Calling_Routing_Address_Available trigger, and sends an AnalyzedInformation (ANLYZD) to the SCP.

Step 7: The SCP sends an analyzed response message analyzd to the MSC to indicate that the subsequent call processing should continue.

Step 8: The MSC connects with the called party, and sends an initial address message (IAM) to the called switch.

Step 9: The called switch returns an address complete message (ACM).

Step 10: The called subscriber disconnects, and the called switch sends an acknowledge message ANM to the MSC.

Step 11: The MSC sends an originating answer message OANSWER to the SCP.

Step 12: The SCP, upon receipt of the OANSWER, according to a preset charging rate and charging policies, works out the current call cost and the current account balance. The SCP sends to the MSC a call control directive message CCDIR which includes a charging information parameter ChargeInfo comprising the charging information such as the current call cost and the current account balance.

Step 13: The MSC, upon receiving the CCDIR, determines by analysis that the message includes the ChargeInfo parameter, and transparently transmits the cost information in the parameters. The cost information may be sent to the BSC in a Flash with Information message, and finally may be sent to the WIPT terminal which displays the cost information. At the same time, the MSC returns a call control directive response message ccdir to the SCP. Those skilled in the art should understand that, the cost information displayed by the WIPT terminal may be the current call cost, or the account balance, or a combination of the two, or other charging information.

During a conversation, the SCP periodically, such as per minute interval, sends the CCDIR to the MSC. The content of the CCDIR and the sending process are consistent with above Steps 12 and 13. The concrete timing duration may be configured. Here, the cost information displayed by the WIPT terminal may be the information such as the current call cost, the call duration, the account balance, or any combination of the above three.

In the case that the terminal ends the call, the MSC sends an originating disconnect message ODISCONNECT to the SCP, and the SCP sends to the MSC an originating disconnect response message odisconnect including an extended ChargeInfo parameter which includes the charging information such as the call cost and the account balance. According to the protocols, the odisconnect does not include the ChargeInfo parameter, and therefore, an extended configuration needs to be made in advance to enable the MSC and the SCP receiving and sending the parameter in the odisconnect message.

The MSC receives the odisconnect message, determines that the message includes the ChargeInfo parameter, transparently transmits the charging information in the parameter, and sends the charging information to the BSC in a Feature Notification message. Finally, the charging information may be sent to the WIPT terminal. Those skilled in the art should understand that, the charging information displayed by the WIPT terminal may be the final call cost, call duration, account balance, or any combination of the above three, or other charging information of this call. The operator running the WIPT charges the subscribers according to the charging information.

In order to decrease the number of times of the SCP sending the CCDIR, and to ensure that the cost information displayed in the WIPT terminal is not influenced in the case that the message carrying the charging information is lost now and then, the charging information sent by the SCP may include a metering duration and a metering cost. The WIPT terminal, before receiving the next charging information, automatically and periodically updates the displayed charging information based on the metering duration and the metering cost. For example, assume that making a local call by a mobile phone costs 0.50 yuan per minute, that is, when the metering duration is 60 second, the metering cost is 0.50 yuan.

It is assumed that the charging information included in the ChargeInfo sent to the terminal by the SCP includes the call cost (C-Cost, the call cost from the beginning to now, the value in the case of the first CCDIR is 0.50), the account balance (B-Balance), the metering duration (T-Time) and the metering cost (F-Fee). The WIPT terminal may calculate and update the current call cost (provided as F1) and the account balance (provided as B1) automatically. The process of the WIPT terminal automatically calculating the call cost and the account balance and updating the display is described below.

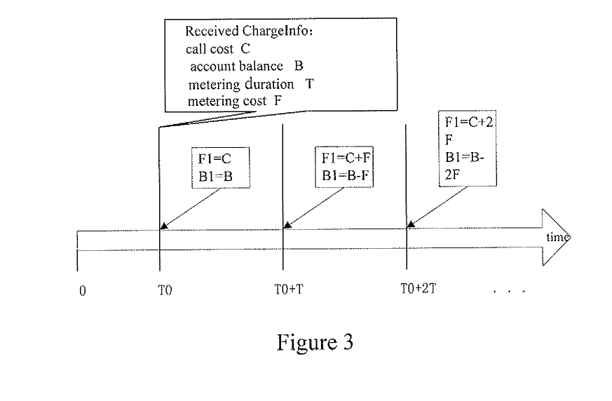

Upon receipt of the charging information (ChargeInfo), the WIPT terminal displays the call cost and the account balance in the charging information for the subscriber, and updates the call cost and the account balance periodically according to the metering duration (T) in the charging information. That is, when per metering duration T passes, the call cost is increased one metering cost F and the account balance is decremented one metering cost F, as shown in FIG. 3. When it receives new charging information, the WIPT terminal repeats the above processes. By this processing mechanism, the following may be implemented.

According to the present invention, although in the case that the number of times of sending the CCDIR by the SCP is decreased, the WIPT terminal may also timely update and display the charging information, thereby enhancing the performance of the system.

Furthermore, although in the case that the message carrying the charging information is lost now and then, in each stage of sending the message from the SCP to the MSC, from the MSC to the BSC and from the BSC to the terminal, the charging may not be influenced.

According to the description of the present invention, those skilled in the art may implement the WIPT terminal of the present invention by using known technologies.

The foregoing is only the preferred embodiment of this invention and is not for use in limiting this invention. The invention is to cover all the modifications, variations and equivalent replacements within the spirit and scope of the disclosure as defined by the appended claims.

What is claimed is:

1. A method for implementing wireless intelligent services, comprising:
receiving a call and triggering an intelligent service corresponding to the call at a Service Control Point (SCP);
receiving a processing result of the intelligent service sent from the SCP;
routing the call to a called party according to the processing result;
receiving a call control directive message carrying charging information sent from the SCP; and
sending the charging information in the call control directive message to a wireless communication terminal.

2. The method of claim 1, wherein sending the call control directive message carrying the charging information by the SCP comprises:
sending call control directive messages carrying the charging information to the MSC periodically during the call.

3. The method of claim 2, further comprising:
receiving an extended originating disconnect response message which carries final charging information of the call from the SCP and sending the final charging information to the wireless communication terminal.

4. The method of claim 3, wherein sending the charging information in the call control directive message and the final charging information in the extended originating disconnect response message to the wireless communication terminal comprises:
transparently transmitting the charging information in the call control directive message and the final charging information in the extended originating disconnect response message to a Base Station Controller (BSC); and
transmitting the charging information and the final charging information to the wireless communication terminal by the BSC.

5. The method of claim 3, wherein the extended originating disconnect response message comprises a charging information parameter, and the charging information parameter comprises the final charging information.

6. The method of claim 5, wherein the charging information parameter comprises the charging information in the call control directive message.

7. The method of claim 1, wherein when the SCP learns that the MSC has received an answering message from the called party, the charging information sent by the SCP comprises at least one of call cost and an account balance.

8. The method of claim 7, wherein the charging information further comprises a metering duration and a metering cost; and displaying the charging information by the wireless communication terminal comprises:
periodically updating the charging information according to the metering duration and the metering cost and displaying the updated charging information.

9. The method of claim 8, wherein the charging information displayed by the wireless communication terminal comprises at least one of the call cost, call duration, and the account balance.

10. The method of claim 1, wherein the called party is one of a Public Switched Telephone Network (PSTN) terminal, and a wireless mobile communication network terminal.

11. The method of claim 1, wherein processing the intelligent service by the SCP comprises;
authenticating a calling number which initiates the call; and
acquiring an account corresponding to the calling number to record subsequent call cost in the account.

12. The method of claim 1, wherein processing the intelligent service by the SCP comprises:
authenticating a calling number which initiates the call; and
acquiring telephone card information by a collect digits upon announcement way to record subsequent call cost in an account corresponding to the telephone card.

13. The method of claim 1, further comprising:
displaying the charging information by the wireless communication terminal.

14. A system for implementing wireless intelligent services, comprising a Mobile Switching Center (MSC), a Service Control Point (SCP) and a wireless communication terminal, wherein
the MSC is configured to receive a call and trigger an intelligent service corresponding to the call at the SCP; receive a processing result of the intelligent service from the SCP; route the call to a called party according to the processing result; receive a call control directive message carrying charging information sent from the SCP; and send the charging information in the call control directive message to the wireless communication terminal;
the SCP is configured to process the intelligent service and send the call control directive message candying charging information; and
the wireless communication terminal is configured to display the charging information.

15. The system of claim 14, further comprising a Base Station Controller (BSC), for receiving the charging information from the MSC and sending the charging information to the wireless communication terminal.

16. A Mobile Switching Center (MSC), comprising:
a component configured to:
receive a call and triggering an intelligent service corresponding to the call at the SCP;
receive a processing result of the intelligent service from the SCP; routing the call to a called party according to the processing result;
receive a call control directive message carrying charging information sent from the SCP; and
send the charging information in the call control directive message to the wireless communication terminal.

17. A Service Control Point (SCP), comprising:
a unit for processing an intelligent service; and
a unit for sending a call control directive message carrying charging information to a Mobile Switching Center (MSC).

18. The SCP of claim 17, further comprising:
a unit for authenticating a calling number which initiates a call corresponding to the intelligent service; and
a unit for acquiring an account corresponding to the calling number to record subsequent call cost of the call in the account.

19. The SCP of claim 17, wherein the unit for processing the intelligent service comprises:
a unit for authenticating a calling number which initiates a call corresponding to the intelligent service; and
a unit for acquiring telephone card information by a collect digits upon announcement way to record subsequent call cost of the call in an account corresponding to the telephone card.

20. A wireless communication terminal, comprising:
a component configured to:
receive charging information from a Mobile Switching Center (MSC); and
display the charging information.
